(19) United States
(12) Patent Application Publication
(10) Pub. No.: US 2026/0091467 A1
(43) Pub. Date: Apr. 2, 2026

(54) MANUAL DEBURRING TOOL

(71) Applicant: SAFRAN AIRCRAFT ENGINES, Paris (FR)

(72) Inventors: Nicolas HALLIER, Moissy-Cramayel (FR); Philippe MONTIGNY, Moissy-Cramayel (FR); Alain DANIEL, Moissy-Cramayel (FR); Mickael BEAURAIN, Moissy-Cramayel (FR)

(21) Appl. No.: 19/111,038

(22) PCT Filed: Sep. 4, 2023
(86) PCT No.: PCT/FR2023/051324

§ 371 Date: Mar. 12, 2025

(30) Foreign Application Priority Data
Sep. 12, 2022 (FR) 2209110

(51) Int. Cl. B24D 15/02

(52) U.S. Cl. CPC B24D 15/02

(57) ABSTRACT

A manual deburring tool including a consumable carbide plate having deburring edges, and a casing which is configured to be grasped manually and has an internal cavity for housing the plate, the casing including a body and a cover removably attached to the body so as to allow the insertion of the plate into the cavity and the removal of said plate from the cavity, the housing including at least one opening that opens into the cavity and exposes a deburring edge.

### TECHNICAL SCOPE OF THE INVENTION

The invention relates to the technical field of manual tools for deburring and adjusting workpiece surfaces, for example by fettling or rounding an angle.

### TECHNICAL BACKGROUND

The technical background includes in particular the documents CH-A-479 358, US-A1-2018/250843, US-A1-2021/213544 and US-A1-5 054 201.

The finishing of workpieces, particularly raw metal workpieces, involves a number of manual adjustment operations, including deburring, fettling or even breaking or rounding an angle. Deburring is the process of removing excess metal or burrs from a workpiece. This type of defect can appear on a workpiece after machining operations such as milling or turning. Fettling is an operation designed to remove unwanted protrusions from the surface of a workpiece, while rounding an angle is aimed at eliminating cutting ridges.

Up to now, when manually adjusting workpieces, the operator has used a carbide plate to remove the burr resulting from a previous operation. However, the use of carbide plates as is has proved unsuitable both for the operator and for the workpiece on which the finishing operations are carried out. In fact, the operator is exposed to the risk of cuts when using the plate, and there is a risk of shocks and scratches on the workpiece, impacting on the quality of the workpiece and delivery times. Furthermore, in the absence of appropriate tools, the operator may be led to use other tools not validated in the tooling repository, resulting in non-compliance with quality rules. This applies particularly to the manufacture of workpieces in the aeronautical field, such as for example the manufacture of turbomachine workpieces. In fact, the workpieces of the turbomachines can be very large, and the manual adjustment operations of these workpieces can be long and delicate.

The purpose of the invention is to provide a manual tool for deburring and adjusting workpiece surfaces, allowing damage to the workpiece, the risk of cutting the operator and the consequences of such situations to be avoided.

### SUMMARY OF THE INVENTION

In fact, the invention proposes a manual deburring tool comprising:
a consumable carbide plate, this plate having deburring edges, and
a casing which is configured to be grasped manually and which comprises an internal cavity for housing the plate, this casing comprising a body and a cover removably attached to the body so as to allow the insertion of the plate into the cavity and the removal of said plate from the cavity, the casing comprising at least one opening that opens into the cavity and exposes a deburring edge of the plate.

When using the manual tool according to the invention, the operator is no longer in direct contact with the carbide plate, but with the casing. In fact, when the casing is closed, i.e. when the cover is closed, only said or each deburring edge of the carbide plate is exposed through the openings. In this way, the casing offers protection to the operator, who no longer grasps the carbide plate directly, but grasps the casing enclosing the plate. In addition, the risk of impact with a surface of the workpiece to be finished is considerably reduced, since only the deburring edges of the plate remain exposed.

According to various characteristics of the invention which may be taken together or separately:
the tool comprises several openings;
the openings have a depth of between 2 mm and 8 mm;
the openings have dimensions smaller than the dimensions of the plate other than a thickness of said plate;
the cavity has dimensions adjusted to the dimensions of the plate;
the body comprises two guides, the cover comprising two lateral longitudinal flanges adapted to cooperate with the guides by a sliding connection;
the casing comprises a recess adapted to cooperate with a lug on the cover;
the casing is made of a plastic material with a breaking strength of between 35 J/m² and 52 J/m², preferably between 44 J/m² and 48 J/m²;
the external face of the casing comprises a knurling defining a plastic structure with an arithmetic mean roughness of between 0.2 and 0.3 μm;

The invention further relates to a method for deburring a workpiece by means of a manual tool as previously described, said workpiece comprising a ridge at which there is a burr, the method comprising the following steps:
bringing one of the edges of the plate into contact with the ridge through one of the openings, and
moving the edge of the plate in contact with the ridge along the ridge.

Advantageously, the workpiece is a workpiece of an aircraft turbomachine, and in particular a rotor drum.

### BRIEF DESCRIPTION OF FIGURES

Other objects, characteristics and advantages of the invention will become clearer in the following description, made with reference to the appended figures, in which:

FIG. 1 illustrates a perspective view of a manual deburring tool according to an embodiment of the present invention;

FIG. 2 illustrates an example of a carbide plate for a manual deburring tool according to an embodiment of the present invention;

FIG. 3 shows a side view of a workpiece to be finished using the manual deburring tool according to the invention;

FIG. 4a is a cross-section of the casing of the manual deburring tool according to an embodiment of the present invention;

FIG. 4b is a side view of the casing of the manual deburring tool according to an embodiment of the present invention;

FIG. 5 illustrates a top view (without the cover) of the casing of the manual deburring tool according to an embodiment of the present invention;

FIG. 6a is a side view of the cover of the manual deburring tool according to an embodiment of the present invention;

FIG. 6b is a cross-section of the cover of the manual deburring tool according to an embodiment of the present invention;

FIG. 6c is a top view of the cover of the manual deburring tool according to an embodiment of the present invention.

### DETAILED DESCRIPTION OF THE INVENTION

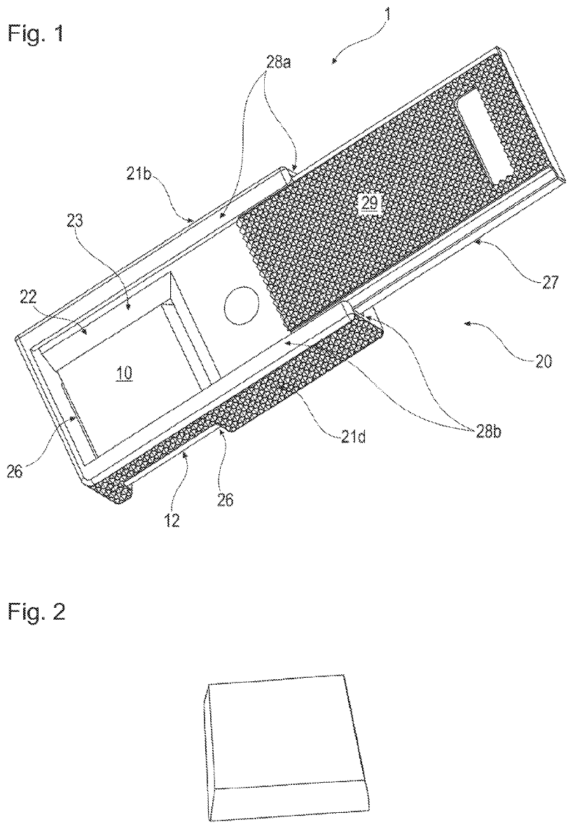

With reference to FIG. 1, the invention concerns a manual tool 1 for deburring and adjusting the surface of a workpiece P. A definition of deburring is given in the preamble to this description and is not repeated here. The adjusting workpiece surfaces refers to any operation aimed at modifying the surface of the workpiece, including fettling or rounding the angle, the definitions of which are also given in the preamble to this description.

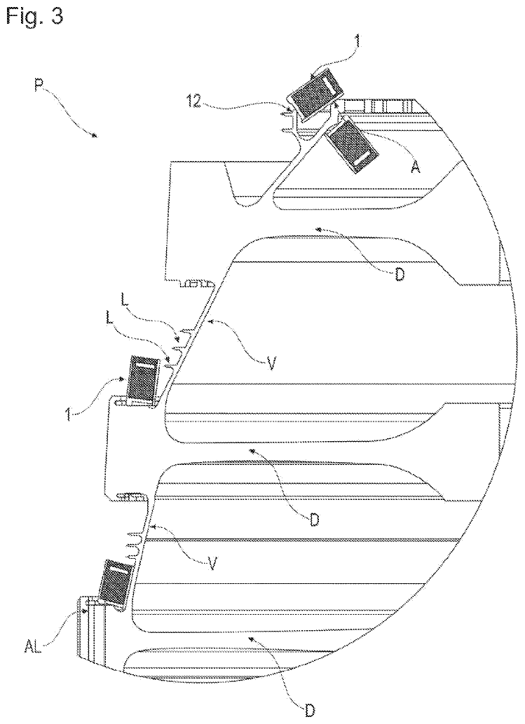

The manual tool 1 comprises a consumable carbide plate 10 with deburring edges 12. These allow any finishing operations such as those seen above to be carried out. FIG. 3 illustrates how the workpiece finishing can be carried out using manual tool 1. The carbide plate 10 is a consumable and can therefore be changed after wear or damage, for example because its deburring edges are worn.

Preferably, the carbide plate 10 is a silicon carbide plate.

The plate 10, for example, has the general shape of a truncated pyramid, so that its deburring edges 12 are inclined. In this embodiment, a base of the truncated pyramid corresponds to a lower face of the plate, while a plane at which the pyramid is truncated corresponds to an upper face of the plate. It should be noted that the terms “lower” and “upper” are not limitative in the context of the present invention, and are only used to describe the invention with reference to the embodiments illustrated in the figures. Preferably, the lower face of the plate is that which faces a bottom of a cavity of the manual tool 1. As can be seen from the figure, the deburring edges 12 are more precisely inclined outwards from the upper face towards the lower face. This will be discussed further below.

In the example shown in FIG. 3, the workpiece P is an aircraft turbomachine rotor, and more specifically a rotor drum, which is shown here in partial axial section. Classically, this drum has a generally annular shape around an axis and comprises disks D interconnected by an annular web V. At its external periphery, the disk comprises pockets AL for mounting the vane roots, and the web comprises annular lips L extending radially outwards. The manual tool 1 is used to remove the burrs located at the ridges A or to round the angle of the ridges located, for example, in the connecting areas of the web to the discs, as illustrated in the drawing.

The manual tool 1 further comprises a casing 20 which is configured for manual grasping. The casing 20 comprises an internal cavity 22 for housing a carbide plate 10. According to one embodiment of the present invention, the cavity 22 has dimensions adjusted to the dimensions of the carbide plate 10 so that there is little or no clearance between the plate 10 and the cavity 22. When there is no clearance between plate 10 and cavity 22, the plate 10 is held fixedly or immovably in the cavity 22. The casing 20 further comprises a body 25 and a cover 27 removably attached to the body so as to allow the insertion of the carbide plate 10 into the cavity 22 and the removal of the carbide plate 10 from the cavity 22.

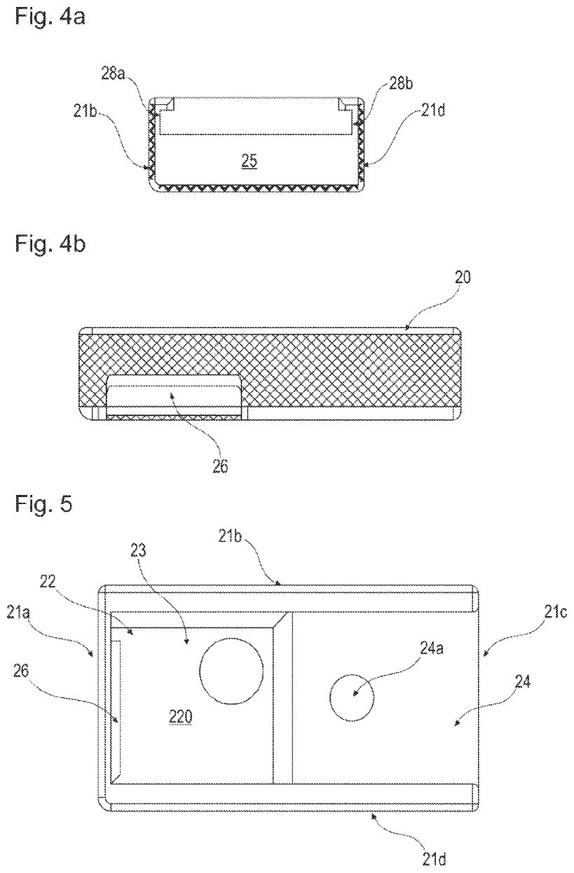

According to the invention, the casing 20 comprises at least one opening 26 (visible in FIG. 4b) opening into the cavity 22 and exposing a deburring edge 12 of the carbide plate. This being said, the casing advantageously comprises several openings 26, allowing the deburring edges of the plate to be further exposed. As previously mentioned, the deburring edges 12 are inclined outwards from the upper face towards the lower face, so that when the plate 10 is in a cavity 22 with its lower face in contact with the bottom of the cavity 22, the deburring edges 12 are closer to the openings 26 than the other parts of the plate 10.

In the embodiment shown in FIGS. 1 and 5, body 25 is parallelepipedal in shape. The cavity 22 can be positioned so that one or more of its lateral faces are adjacent to one or more lateral walls 21a, 21b, 21c, 21d of the body 25 or located at the level of one or more lateral walls 21a, 21b, 21c, 21d of the body 25. By altering the distance between the lateral faces of the cavity and the facing lateral walls 21a, 21b, 21c, 21d of the body, it is possible to alter the depth of the openings 26. In fact, the depth of an opening corresponds to the distance separating the lateral face of the cavity where the opening is located from an outer face of the lateral wall of the body where said opening opens out. Each lateral face of the cavity defines an internal face of the casing, while for each lateral wall of the body, the outer face corresponds to an external face of the casing.

Preferably, the openings 26 have a depth of between 2 mm and 8 mm. A minimum depth of 2 mm ensures that the deburring edges 12 are sufficiently recessed in relation to the outer surface of the casing. At the same time, this also means that the wall thickness is 2 mm, which also allows good mechanical strength of the casing 20. A depth of up to 8 mm allows a manual tool 1 of appropriate dimensions to be kept handy, while guaranteeing access to the deburring edge 12. In fact, the greater the depth of the openings 26, the greater the other dimensions of the openings 26 will have to be for the deburring edges 12 to remain accessible from the workpiece P, and the less manipulable the manual tool 1 according to the invention will be.

In the proposed embodiment, tool 1 comprises several openings 26. However, this is not necessary, nor is it outside the scope of the invention, if the tool has only one opening.

Nevertheless, when the tool has several openings, it is possible to position the tool optimally in relation to the surface of the object to be treated by the tool. In addition, having several openings reduces the need to move the plate once the first edge of it has been worn away by use, as all the edges of the plate opposite an opening are then worn away during use.

For example, an opening can be arranged on three of the four edges of the casing of the tool 1.

Advantageously, the openings 26 have dimensions smaller than the dimensions of the carbide plate 10, other than the thickness of said carbide plate, which allows the plate 10 to be prevented from coming out of the casing after insertion into the cavity. In particular, the openings 26 have a width and length less than the length and width of the plate 10.

Still according to the embodiment shown in FIG. 1, the internal cavity 22 for housing the plate comprises an access 23 extending transversely to the lateral walls of the cavity, through which the plate 10 can be inserted. Alternatively, a slot could be used to allow lateral insertion of the carbide plate 10. This solution is less attractive, however, as it would require additional means of closing cavity 22. The access 23 is closed by means of the cover 27. In FIG. 1, the cover 27 is positioned appropriately for insertion of the plate 10 into the cavity 22. That said, the position of cover 27 may vary. In this respect, the body 25 comprises two guides 28a, 28b with which longitudinal edges 27a, 27b of the cover are able to cooperate. In the example shown in FIG. 4a, the guides 28a, 28b take the form of parallelepipedal recesses in the lateral walls 21b, 21d of the casing. As can be seen in FIG. 1, the guides 28a, 28b are formed along the edges of lateral walls 21b and 21d and the access 23. The cover 27 thus forms a sliding connection with the body 25, allowing it to move from a proximal position in which it completely covers the cavity 22, and thus closes the casing 20, to a distal position in which the access 23 is completely free, the casing 20 then being opened, passing through successive intermediate positions.

When the cover 27 completely covers the cavity 22, the deburring edges 12 are the only parts of the plate 10 that are exposed, as previously indicated, via the openings 26. Thus, the risks of cutting the operator and damaging the workpiece to be finished are greatly reduced, if not eliminated, by using the manual tool 1 according to the invention. In fact, the surface handled by the operator is protected by the casing 20. Additionally, if the manual tool 1 comes into contact with another surface of the workpiece during finishing operations, it is with a surface protected by the casing 20, since the latter covers most of the plate 10. As already mentioned, the openings 26 can have a depth of between 2 mm and 8 mm, so that the deburring edges 12 are set back from the outer surface of the casing 20.

FIG. 5 illustrates in greater detail the arrangement of cavity 22 and the other elements located inside the casing 20. As already indicated, in the illustrated embodiment, the cavity 22 is located in the immediate vicinity of one or more of the lateral walls 21a, 21b, 21c, 21d. In this case, it is located in the immediate vicinity of the lateral walls 21a, 21b and 21d. It comprises a base 220 on which the carbide plate 10 rests.

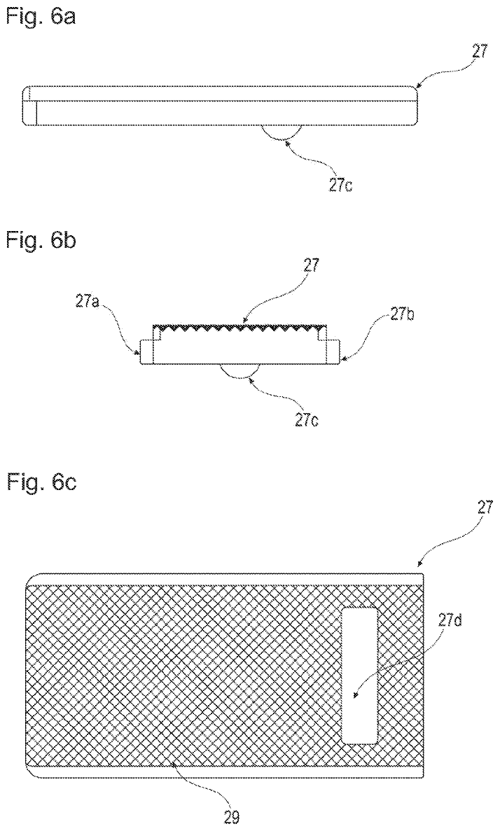

On the right-hand side of the casing, as shown in FIG. 5, a solid portion 24 adjoins the cavity 22. The solid portion 24 comprises a recess 24a in which a lug 27c located on the face of the cover 27 facing the inside of the casing 20 is intended to be housed. An example of the arrangement of the lug 27c with respect to the cover is shown in FIGS. 6a and 6b. Such an arrangement allows displacement of the cover 27 to be limited, and even locks cover 27 with respect to the casing 20. The locking takes place once the cover is in the proximal position, i.e. when it completely closes the cavity 22. The locking allows the tool to be used even more easily, as it ensures that, whatever the position of the tool, the cover is not reopened during use.

Referring now to FIG. 6c, the cover 27 may also include an opening 27d allowing the operator to grasp the cover 27 and slide it along guides 28a, 28b. As can be better understood from FIG. 1, when the cover is in the proximal position and closes the cavity 22, the opening 27d is positioned so as to face the solid portion 24, allowing the companion to grasp the cover easily and securely.

Advantageously, the casing 20 is made of a plastic material with a breaking strength of between 35 J/m² and 52 J/m², preferably between 44 J/m² and 48 J/m². This makes the casing more robust and reduces wear. Such breaking strength is achieved, for example, with ACCURA's Xtreme® gray plastic. Other plastics with a breaking strength in the above-mentioned range can also be used. It should be noted that advantageously, ACCURA's Xtreme® grey can be used in additive manufacturing methods. Thus, the casing 20 of the manual tool 1 according to the invention can be manufactured by additive manufacturing. Other plastic materials that can be used in additive manufacturing or in conventional manufacturing, and which have the aforementioned breaking strength, are available to the person skilled in the art.

As illustrated in the figures, the casing 20 can be produced by knurling machining defining the plastic structure 29 with an arithmetic mean roughness of between 0.2 and 0.3 μm. Knurling is understood here as an alternation of bumps and valleys, and the arithmetic roughness of knurling is defined as the characteristic depth, i.e. the difference between the top of a bump and the bottom of a valley. Increasing the surface roughness of the casing 20 by knurling allows it to have anti-slip properties. This improves the grasp of the manual tool by the operator, while avoiding the risk of cuts. In fact, the non-slip coating improves grasp between the personal protective equipment worn by the operator and the casing 20.

A method for deburring a workpiece using a manual tool 1 as described above is described in the following. A workpiece P is provided, comprising a ridge A at which there is burr resulting from a prior turning or milling step on the workpiece. The method comprises a step during which one of the edges of the carbide plate is brought into contact with the ridge A through one of the openings 26, then another step during which the edge of the plate in contact with the ridge is moved along the ridge. In this way, the ridge A is rubbed or slid with one of the deburring edges 12 of the manual tool 1 to remove the burr. Using the manual tool according to the invention is therefore both simple and secure for the operator.

The configurations shown in the figures are only possible examples, in no way limiting, of the invention which, on the contrary, encompasses all the variations in shape and design within the reach of the person skilled in the art.

1. A manual deburring tool comprising:
a consumable carbide plate, this plate having deburring edges, and
a casing which is configured to be grasped manually and has an internal cavity for housing the plate, this casing comprising a body and a cover removably attached to the body so as to allow the insertion of the plate into the cavity and the removal of said plate from the cavity, the casing comprising at least one opening that opens into the cavity and exposes a deburring edge of the plate.

2. The manual tool according to claim 1, wherein the openings have a depth of between 2 mm and 8 mm.

3. The manual tool of claim 1, wherein the openings have dimensions smaller than the dimensions of the plate other than a thickness of said plate.

4. The manual tool according to claim 1, wherein the cavity has dimensions adjusted to the dimensions of the plate.

5. The manual tool according to claim 4, wherein the body comprises two guides, the cover comprising two lateral longitudinal flanges (27a, 27b) adapted to cooperate with the guides by a sliding connection.

6. The manual tool according to claim 4, wherein the casing comprises a recess adapted to cooperate with a lug on the cover.

7. The manual tool according to claim 1, wherein the casing is made of a plastic material with a breaking strength of between 35 J/m² and 52 J/m², preferably between 44 J/m² and 48 J/m².

8. The manual tool according to claim 1, wherein the external face of the casing comprises a knurling defining a plastic structure (29) with an arithmetic mean roughness of between 0.2 and 0.3 μm.

9. A method for deburring a workpiece by means of a manual tool according to claim 1, said workpiece (P) comprising a ridge (A) at which there is burr, the method comprising the following steps:
bringing one of the edges of the plate into contact with the ridge (A) through one of the openings, and
moving the edge of the plate in contact with the ridge along the ridge.

10. The method according to claim 9, wherein the workpiece is a workpiece of an aircraft turbomachine, and in particular a rotor drum (P).
